(19) United States
(12) Patent Application Publication
(10) Pub. No.: US 2026/0205164 A1
(43) Pub. Date: Jul. 16, 2026

(54) METHOD AND APPARATUS FOR CONTROLLING RECONFIGURABLE INTELLIGENT SURFACE DEVICE

(71) Applicant: SAMSUNG ELECTRONICS CO., LTD., Suwon-si, Gyeonggi-do (KR)

(72) Inventors: Hanjin KIM, Suwon-si (KR); Seunghyun LEE, Suwon-si (KR); Huiwon KIM, Suwon-si (KR); Juho LEE, Suwon-si (KR)

(21) Appl. No.: 19/134,143

(22) PCT Filed: Jan. 18, 2024
(86) PCT No.: PCT/KR2024/000902

§ 371 Date: May 29, 2025

(30) Foreign Application Priority Data
Jan. 18, 2023 (KR) 10-2023-0007363

(51) Int. Cl. H04B 7/04; H04B 17/345; H04W 24/08; H04W 24/10

(52) U.S. Cl. CPC H04B 7/04013; H04B 17/345; H04W 24/08; H04W 24/10

(57) ABSTRACT

The present disclosure relates to a 5G or 6G communication system for supporting a higher data transmission rate than a 4G communication system such as LTE. According to an embodiment, a base station, which controls a reconfigurable intelligent surface (RIS) device in a wireless communication system, comprises a transceiver and a control unit. The control unit may: control to transmit RIS-interference measurement (IM) resource configuration information including first information allocating an RIS-IM resource for each RIS reflecting pattern (RP) of the RIS device and second information indicating period information regarding the RIS-IM resource; and control to transmit, to a terminal, report configuration information regarding the RIS-IM resource. The RIS-IM resource may be a reference source that is configured for the terminal to measure a signal through the RIS device.

### TECHNICAL FIELD

The disclosure relates to a communication method and device using reconfigurable intelligent surface (RIS) technology in a wireless communication system.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 psec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner, an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Meanwhile, reconfigurable intelligent surface (RIS) technology is being researched as one of the next-generation communication technologies. In RIS technology, a reflection pattern of reflecting elements (REs) included in the RIS device is formed as a combination of phase and/or amplitude, and the transmission beam of the base station incident on the RIS device may be reflected in a desired direction according to the reflection pattern.

### DETAILED DESCRIPTION OF THE INVENTION

### Technical Problem

It is possible to transfer the transmission beam incident on the RIS device to the UE located in the shadow area where the transmission beam cannot reach from the base station by reflecting the transmission beam.

Meanwhile, there is a growing need for a method for supporting mitigation of neighbor cell interference with a UE using an RIS device.

### Technical Solution

According to an embodiment, a base station controlling a reconfigurable intelligent surface (RIS) device in a wireless communication system may comprise a transceiver, and a controller. The controller may control to transmit RIS-IM resource configuration information including first information for allocating an RIS interference measurement (IM) resource for each RIS reflecting pattern (RP) of the RIS device and second information indicating periodicity information about the RIS-IM resource, and control to transmit report configuration information about the RIS-IM resource to a user equipment (UE). The RIS-IM resource may be a reference resource configured for signal measurement through the RIS device by the UE.

According to an embodiment, the controller may receive, from the UE, measurement information obtained by measuring a signal transmitted through the RIS device by the UE in the RIS-IM resource based on the report configuration information.

According to an embodiment, a different RIS-IM resource may be allocated to each of a plurality of RIS RPs implemented in the RIS device, and a number of the RIS-IM resources may be preset.

According to an embodiment, the controller may transmit the second information including a slot periodicity through higher layer signaling, or transmit the second information including an RIS-IM resource set triggering field through downlink control information (DCI).

According to an embodiment, the report configuration information about the RIS-IM resource may be transmitted through higher layer signaling.

According to an embodiment, the report configuration information about the RIS-IM resource may be configured for the UE to report an RIS-IM index where a smallest reference signal received power (RSRP) or received signal strength indicator (RSSI) is measured among a plurality of RIS-IM indexes and the RSRP or the RSSI.

According to an embodiment, the controller may periodically receive, from the UE, the measurement information measured by the UE through a physical uplink control channel (PUCCH), or aperiodically receive, from the UE, the measurement information measured by the UE through a physical uplink shared channel (PUSCH).

According to an embodiment, the controller may transmit data on a physical downlink shared channel (PDSCH) using an RIS-RP mapped to the RIS-IM index where the smallest RSRP or RSSI is measured, received from the UE.

According to an embodiment, the RIS-IM resource may be allocated in a slot unit, and include an RIS off resource for a specific RIS RP to measure a size that offsets inter-cell interference (ICI).

According to an embodiment, the controller may determine whether the RIS device is used for coverage extension or for mitigating inter-cell interference (ICI), and control to transmit control information corresponding to the determination to the RIS device.

According to an embodiment, the controller may determine whether the RIS device is used for the coverage extension or for mitigating the ICI, compares an increment of a received signal strength indicator (RSSI) or RSRP measured through a channel status information-reference signal (CSI-RS) when the RIS device is used for the coverage extension with a decrement of the RSSI or RSRP measured through the RIS-IM resource when the RIS device is used for mitigating the ICI.

According to an embodiment, if the increment of the RSSI or RSRP when the RIS device is used for the coverage extension is larger than the decrement of the RSSI or RSRP when the RIS device is used for mitigating the ICI, the controller may determine that the RIS device is used for the coverage extension. According to an embodiment, if the increment of the RSSI or RSRP when the RIS device is used for the coverage extension is smaller than the decrement of the RSSI or RSRP when the RIS device is used for mitigating the ICI, the controller may determine that the RIS device is used for mitigating the ICI.

According to an embodiment, a UE measuring a signal using a reconfigurable intelligent surface (RIS) in a wireless communication system may comprise a transceiver, and a controller. The controller may receive, from a base station, RIS-IM resource configuration information including first information for allocating an RIS interference measurement (IM) resource for each RIS reflecting pattern (RP) of the RIS device and second information indicating periodicity information about the RIS-IM resource, and receive, from the base station, report configuration information about the RIS-IM resource. The RIS-IM resource may be a reference resource configured for signal measurement through the RIS device by the UE.

According to an embodiment, a method for operating a base station controlling a reconfigurable intelligent surface (RIS) device in a wireless communication system may comprise transmitting RIS-IM resource configuration information including first information for allocating an RIS interference measurement (IM) resource for each RIS reflecting pattern (RP) of the RIS device and second information indicating periodicity information about the RIS-IM resource, and transmitting report configuration information about the RIS-IM resource to a UE. The RIS-IM resource may be a reference resource configured for signal measurement through the RIS device by the UE.

According to an embodiment, a method for operating a UE measuring a signal using a reconfigurable intelligent surface (RIS) in a wireless communication system may comprise receiving, from a base station, RIS-IM resource configuration information including first information for allocating an RIS interference measurement (IM) resource for each RIS reflecting pattern (RP) of the RIS device and second information indicating periodicity information about the RIS-IM resource, and receiving, from the base station, report configuration information about the RIS-IM resource. The RIS-IM resource may be a reference resource configured for signal measurement through the RIS device by the UE.

### Advantageous Effects

The method and device according to an embodiment of the disclosure may effectively mitigate neighbor cell interference using a reconfigurable intelligent surface (RIS) device.

### BRIEF DESCRIPTION OF DRAWINGS

FIG. 1 is a view illustrating a wireless communication system supporting RIS according to an embodiment of the disclosure;

FIG. 2 illustrates an example of a wireless communication system including an RIS device according to an embodiment of the disclosure;

FIG. 3 illustrates another example of a wireless communication system including an RIS device according to an embodiment of the disclosure;

FIG. 4 illustrates another example of a wireless communication system including an RIS device according to an embodiment of the disclosure;

FIG. 5A illustrates an example of a first pattern of a CSI-IM resource in a wireless communication system, and FIG. 5B illustrates an example of a second pattern of the CSI-IM resource:

FIG. 6 is a view illustrating operations of a base station, an RIS device, and a UE according to an embodiment of the disclosure;

FIG. 7 illustrates an example in which a resource is mapped to each RIS-RP of an RIS device according to an embodiment of the disclosure;

FIG. 8 illustrates a structure of a base station according to an embodiment of the disclosure;

FIG. 9 illustrates a structure of an RIS controller according to an embodiment of the disclosure;

FIG. 10 illustrates a structure of a UE according to an embodiment of the disclosure;

FIG. 11 is a flowchart illustrating operations of a base station, an RIS, and a UE according to an embodiment of the disclosure; and

FIG. 12 is a flowchart illustrating operations of a base station according to an embodiment of the disclosure.

### MODE FOR CARRYING OUT THE INVENTION

Hereinafter, embodiments of the present disclosure are described in detail with reference to the accompanying drawings. The same reference denotations may be used to refer to the same or similar elements throughout the specification and the drawings. When making the gist of the present invention unclear, the detailed description of known functions or configurations is skipped.

In describing the embodiments of the disclosure, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card.

According to embodiments of the disclosure, the base station may be an entity allocating resource to terminal and may be at least one of gNode B, gNB, eNode B, eNB, Node B, base station (BS), wireless access unit, base station controller, or node over network. The base station may be a network entity including at least one of an integrated access and backhaul-donor (IAB-donor), which is a gNB providing network access to UE(s) through a network of backhaul and access links in the NR system, and an IAB-node, which is a radio access network (RAN) node supporting NR backhaul links to the IAB-donor or another IAB-node and supporting NR access link(s) to UE(s). The UE is wirelessly connected through the IAB-node and may transmit/receive data to and from the IAB-donor connected with at least one IAB-node through the backhaul link.

Further, the UE may include a user equipment (UE), a mobile station (MS), a cellular phone, a smart phone, a computer, or various devices capable of performing a communication function. In the disclosure, downlink (DL) refers to a wireless transmission path of signal transmitted from the base station to the terminal, and uplink (UL) refers to a wireless transmission path of signal transmitted from the terminal to the base station. Although the LTE or LTE-A systems may be described below as an example, embodiments of the disclosure may be applied to other communication systems having a similar technical background or channel shape. For example, 5G mobile communication technology (5G, new radio. NR) developed after LTE-A may be included therein, and 5G below may be a concept including legacy LTE, LTE-A and other similar services. Further, the embodiments may be modified in such a range as not to significantly depart from the scope of the present invention under the determination by one of ordinary skill in the art and such modifications may be applicable to other communication systems.

As used herein, terms denoting signals, terms denoting channels, terms denoting control information, terms denoting network entities, and terms denoting device components are provided as an example for ease of description. As used herein, terms for identifying nodes, terms denoting messages, terms denoting inter-network entity interfaces, and terms denoting various pieces of identification information are provided as an example for ease of description. The disclosure is not limited to the terms, and other terms equivalent in technical concept may also be used.

Although the disclosure describes various embodiments using terms used in some communication standards (e.g., 3rd generation partnership project (3GPP)), this is merely an example for description. Various embodiments of the disclosure may be easily modified and applied in other communication systems.

The disclosure relates to reconfigurable intelligent surface (RIS) technology which is a next-generation communication technology. In RIS technology, a reflection pattern of multiple reflecting elements (REs) included in the RIS device is formed as a combination of phase and/or amplitude, and the transmission beam of the base station incident on the RIS device may be reflected in a desired direction according to the reflection pattern. If the RIS device is used, it is possible to transfer the transmission beam of the base station, incident on the RIS device, to the UE by reflecting the transmission beam when the UE is located in the shadow area where the transmission beam cannot reach. Further, if the RIS device is used, it is possible to transfer the transmission beam of the UE, incident on the RIS device from the UE located in the shadow area, to the base station by reflecting the transmission beam.

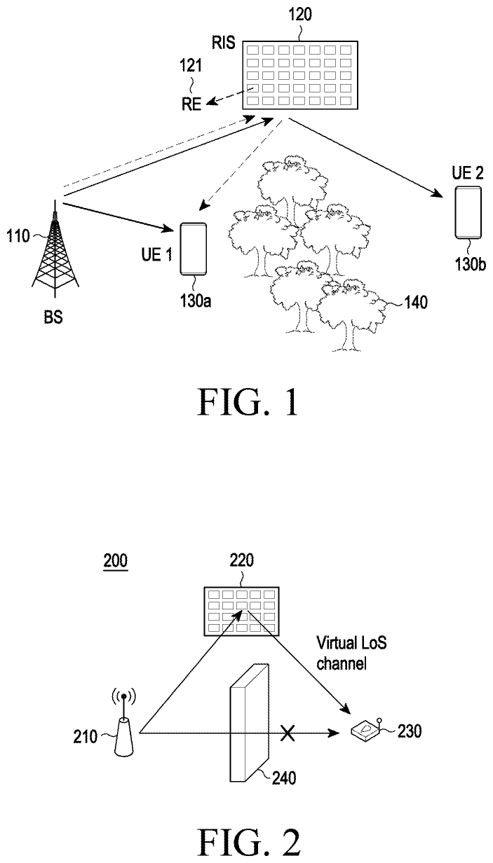

FIG. 1 is a view illustrating a wireless communication system supporting RIS according to an embodiment of the disclosure.

Referring to FIG. 1, a wireless communication system includes a base station (BS) 110, an RIS device 120, a first UE 130a, a second UE 130b, and an obstacle 140.

In FIG. 1, a communication environment where the RIS device 120 is installed around the base station (BS) 110 and the obstacle 140 such as a building or a forest forming a shadow area is around the UEs 130a and 130b may be assumed.

In the communication environment, the first UE 130a located in a line of sight (LoS) from the base station 100 may receive a signal (through a transmission beam) from the base station 100 in a direct path. The second UE 130b located in the shadow area may not receive a signal from the base station 100 through the direct path.

The base station 110 may be connected to the RIS device 120 through a wired or wireless backhaul link, and may provide control information to the RIS device 120. The RIS device 120 controlled by the base station 110 may form a reflecting pattern (RP) of reflecting elements (REs) as a combination of reflection phases and/or amplitudes, and reflect the transmission beam of the base station 110 incident on the RIS device 120 to the second UE 130b in the shadow area according to the reflecting pattern.

The RIS device 120 may include an RIS controller that receives control information from the base station 110 and controls the RIS device 120 based on the control information. The RIS controller may control the reflecting pattern of reflecting elements (REs) implemented in the RIS device 120. According to an embodiment, the RIS controller may be implemented as a hardware device that is physically distinguished from REs. According to an embodiment, the RIS controller may be implemented as a software program and installed in the RIS device 120. According to an embodiment, the RIS controller may be a hardware device or a software program implemented in the base station 110.

The base station 110 may provide RIS beambook information (or RIS codebook information) through a backhaul link to the RIS device 120 capable of reflecting the transmission beam of the base station 110 in the direction of the sound area. The RIS beambook information may include phase shift matrices used for the RIS device 120 to generate reflecting patterns for reflection of the transmission beam of the base station 110, and the phase shift matrix corresponding to each reflecting pattern may be selected from the RIS beambook information. According to an embodiment, the base station 110 may select a reflecting pattern to be applied to the RIS device 120.

FIG. 2 illustrates an example of a wireless communication system including an RIS device according to an embodiment of the disclosure.

Referring to FIG. 2, a wireless communication system 200 includes a base station (BS) 210, an RIS device 220, a UE 230, and an obstacle 240. Due to the obstacle 240, the UE 230 located in the shadow area may not receive a signal transmitted from the base station 210 through a direct path.

The base station 210 may control the RIS device 220 to transmit a signal to the UE 230 located in the shadow area where the signal may not be received through the direct path. According to an embodiment, the RIS device 220 controlled by the base station 210 may form a reflection pattern of REs as a combination of the reflection phase and/or the amplitude, and may reflect the signal of the base station 210 incident on the RIS device 220 to the UE 230 in the shadow area according to the reflection pattern.

The base station 210 may reflect the signal of the base station 210 incident on the RIS device 220 to the UE 230 in the shadow area through a virtual LoS channel. The base station 210 may extend coverage capable of providing a service by transmitting a signal to the UE 230 in the shadow area using the RIS device 220.

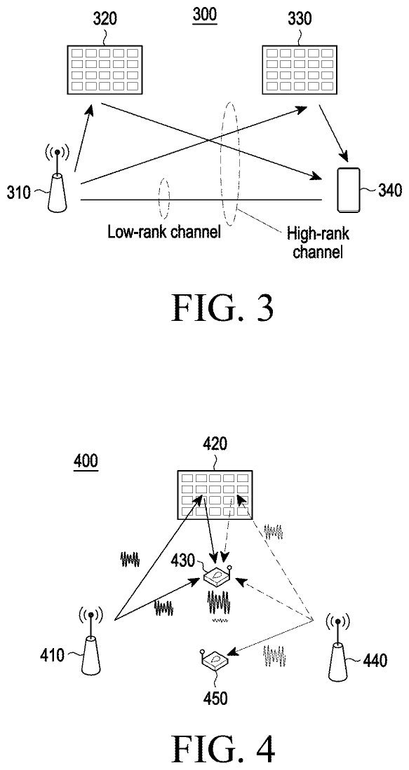

FIG. 3 illustrates another example of a wireless communication system including an RIS device according to an embodiment of the disclosure.

Referring to FIG. 3, a wireless communication system 300 includes a base station (BS) 310, a first RIS device 320, a second RIS device 330, and a UE 340.

The rank may represent the number of paths through which a signal may be independently transmitted in the wireless communication system 300. According to an embodiment, the number of layers represents the number of signal streams transmitted through each path, and the number of ranks may be the same as the number of layers.

In a communication environment where the base station 310 and the UE 340 transmit and/or receive signals through a low-rank channel, the base station 310 may transmit and/or receive signals with the UE 340 through a high-rank channel using at least one of the first RIS device 320 and the second RIS device 330.

The base station 310 may transmit and/or receive a signal with the UE 340 through a first channel corresponding to a direct path, transmit and/or receive a signal with the UE 340 through a second channel passing through the first RIS device 320, and transmit and/or receive a signal with the UE 340 through a third channel passing through the second RIS device 330.

The base station 310 may transmit a control signal for controlling at least one of the first RIS device 320 and the second RIS device 330 to the first RIS device 320 and/or the second RIS device 330 in order to implement a high-rank channel with the UE 340.

FIG. 4 illustrates another example of a wireless communication system including an RIS device according to an embodiment of the disclosure.

Referring to FIG. 4, a wireless communication system 400 includes a first base station 410, an RIS device 420, a first UE 430, a second base station 440, and a second UE 450.

In the wireless communication system 400, the first UE 430 may be located in the coverage of the first cell corresponding to the first base station 410, and the second UE 450 may be located in the coverage of the second cell corresponding to the second base station 440.

The first UE 430 may transmit and/or receive a signal from the first base station 410 through a direct path, and may transmit and/or receive a signal with the first base station 410 through a path passing through the RIS device 420. According to an embodiment, the first UE 430 may be located at an edge of the first cell corresponding to the first base station 410 to receive an interference signal transmitted by the second base station 440. In this case, the interference signal may be referred to as an inter-cell interference (ICI) signal.

The RIS device 420 may be used for mitigation of ICI with the first UE 430. The first UE 430 may receive the interference signal from the second base station 440 through the direct path, and may receive a signal for mitigating the interference signal through the path passing through the RIS device 420.

Referring to FIGS. 2 to 4, the RIS device proposed in the disclosure may be used 1) for coverage extension (e.g., RIS device 220 of FIG. 2), 2) for channel rank enhancement (e.g., first RIS device 320 and/or second RIS device 330 of FIG. 3), or 3) for interference mitigation (e.g., RIS device 420 of FIG. 4).

The base station proposed in the disclosure may control the operation of the RIS device so that the RIS device is used for one of the purposes of 1) to 3). According to an embodiment, a UE located at a cell edge may obtain a larger performance gain using the RIS device for ICI mitigation rather than coverage and rank enhancement.

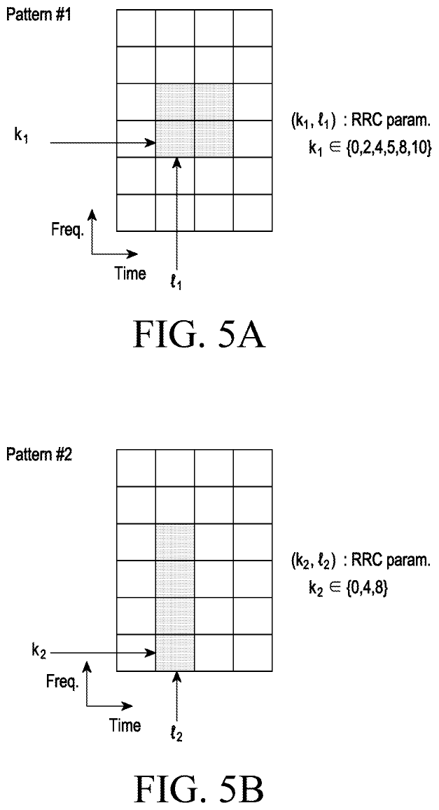

FIG. 5A illustrates an example of a first pattern of a CSI-IM resource in a wireless communication system, and FIG. 5B illustrates an example of a second pattern of the CSI-IM resource.

One or more channel status information-interference measurement (CSI-IM) resource set configuration may be configured in one UE. According to an embodiment, each CSI-IM resource set may be composed of K CSI-IM resources (K≤8).

The CSI-IM resource may be a set of specific resource elements reserved for interference measurement. The CSI-IM resource may be configured by a radio resource control (RRC) message. According to an embodiment, the frequency and time domain location of the CSI-IM resource may be set based on at least one parameter included in the RRC message. According to an embodiment, measurement information measured by CSI-IM may be used when the UE determines channel quality information (CQI).

According to an embodiment, the RRC parameter periodicityAndOffset may define the periodicity and slot offset of the periodic/semi-persistent CSI-IM (e.g., the same IE as CSI-RS). According to an embodiment, the RRC parameter freqBand may indicate the frequency occupancy of the CSI-IM (e.g., the same IE as CSI-RS). According to an embodiment, two RE patterns may be configured for each CSI-IM resource.

Referring to FIG. 5A, the first pattern of the CSI-IM resource may include four resource elements including (k₁,l₁) set in the frequency/time domain based on the RRC parameter.

Referring to FIG. 5B, the first pattern of the CSI-IM resource may include four resource elements including (k₂,l₂) set in the frequency/time domain based on the RRC parameter.

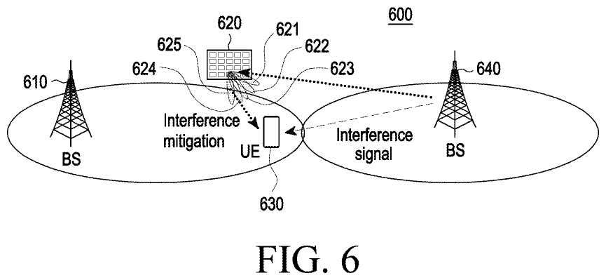

FIG. 6 is a view illustrating operations of a base station, an RIS device, and a UE according to an embodiment of the disclosure.

Referring to FIG. 6, a wireless communication system 600 includes a first base station 610, an RIS device 620, a UE 630, and a second base station 640. A plurality of reflecting patterns (RPs) 621 to 625 for reflecting transmission and/or reception signals may be implemented in the RIS device 620.

In the wireless communication system 600, the UE 630 may be located in the coverage of the first cell corresponding to the first base station 610, and near the coverage of the second cell corresponding to the second base station 640. The UE 630 may transmit and/or receive a signal from the first base station 610 through a direct path, and may transmit and/or receive a signal with the first base station 610 through a path passing through the RIS device 620.

The UE 630 may be located at an edge of the first cell corresponding to the first base station 610 to receive an interference signal transmitted by the second base station 640. In this case, the interference signal may be referred to as an inter-cell interference (ICI) signal.

The RIS device 620 may be used for mitigation of ICI with the UE 630. The UE 630 may receive the interference signal from the second base station 640 through the direct path, and may receive a signal for mitigating the interference signal through at least one of the plurality of reflecting patterns 621 to 625 using the RIS device 620.

The first base station 610 may manage and/or control at least one of the plurality of reflecting patterns 621 to 625 of the RIS device 620 to mitigate ICI with the UE 630 located at an edge of the first cell.

The first base station 610 may configure a reference resource (or RIS-IM) for ICI mitigation and configure a report setting for measurement information about the reference resource (or RIS-IM).

RIS-interference measurement (IM) (or RIS-IM resource) is a zero-power (ZP) reference resource configured for the UE 630 to perform ICI measurement through the RIS device 620. In the RIS-IM, information (or quality) to be reported after measurement may be set differently from CSI-IM. According to an embodiment, one RIS-IM may be mapped to each of the plurality of reflecting patterns 621 to 625. According to an embodiment, RIS-IM resource mapping may be different from CSI-IM.

According to an embodiment, the first base station 610 may map each of the plurality of reflecting patterns 621 to 625 with a reference resource (or RIS-IM). According to an embodiment, the first base station 610 may determine whether to use the RIS device 620 for coverage enhancement, rank enhancement, or ICI mitigation.

According to an embodiment, the first base station 610 may configure an RIS-IM resource setting configuration for ICI mitigation.

According to an embodiment, the first base station 610 may perform time and frequency resource allocation in slot for RIS-IM through a higher layer parameter. According to an embodiment, the first base station 610 may transmit the higher layer parameter to the RIS controller and/or the UE 630 in the RIS device 620. According to an embodiment, the RIS-IM resource may be a resource that needs to feed back report quantities, unlike CSI-IM.

According to an embodiment, the first base station 610 may allocate as many RIS-IM resources as the number of RIS RPs that are operated so that RIS-IM may be mapped per RIS reflecting pattern (RP). According to an embodiment, the first base station 610 may determine and use the number of RIS-IM resources similar to the NR synchronization signal block (SSB). According to an embodiment, the first base station 610 may set the number of RIS-RPs operated through a higher layer parameter.

According to an embodiment, the first base station 610 may set a time periodicity configuration for RIS-IM. According to an embodiment, the first base station 610 may periodically transmit a slot periodicity for RIS-IM to the RIS controller in the RIS device 620 and/or UE 630 through a higher layer parameter (e.g., RRC). According to an embodiment, the first base station 610 may aperiodically include the RIS-IM resource set triggering field in the downlink control information (DCI) field and transmit the same to the RIS controller in the RIS device 620 and/or the UE 630.

According to an embodiment, the first base station 610 may configure a report configuration for RIS-IM. According to an embodiment, the first base station 610 may transmit a report quantity configuration for RIS-IM to the UE 630 through a higher layer parameter (e.g., RRC). According to an embodiment, the first base station 610 may configure the UE 630 to report the RIS-IM index (or best x indices) where the smallest reference signal received power (RSRP) or RSSI is measured during RIS RP-RIS IM mapping and the corresponding RSRP or RSSI value to report.

According to an embodiment, the UE 630 may transmit a report on RIS-IM for quantities set by the first base station 610 through a physical uplink control channel (PUCCH) or a physical uplink shared channel (PUSCH). According to an embodiment, the UE 630 may transmit a periodic report for RIS-IM to the first base station 610 through the PUCCH. According to an embodiment, the UE 630 may transmit an aperiodic report for RIS-IM to the first base station 610 through the PUSCH (e.g., adding the RIS-IM report triggering field in the DCI).

According to an embodiment, the first base station 610 may use and/or configure the RIS RP mapped to the RIS-IM index reported from the UE 630 when transmitting the PDSCH later.

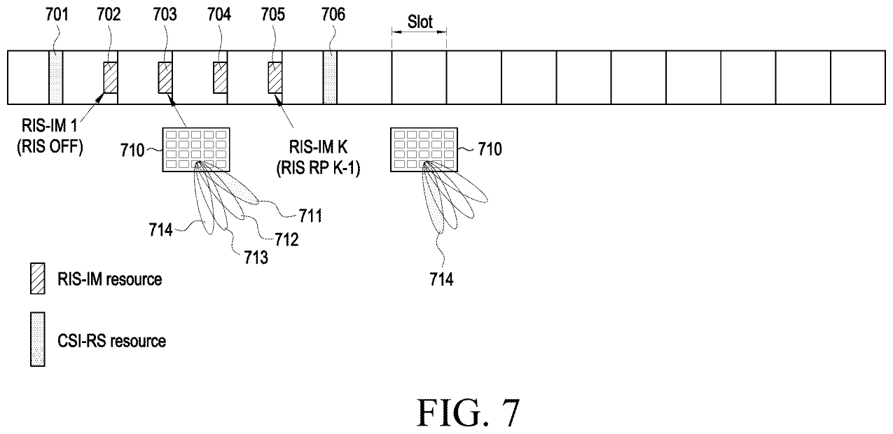

FIG. 7 illustrates an example in which a resource is mapped to each RIS-RP of an RIS device according to an embodiment of the disclosure.

The base station (e.g., the first base station 610 of FIG. 6) may map each RIS RP to the reference resource RIS-IM so that the reflecting pattern (RP) of RIS may be swept to measure the degree of inter-cell interference mitigation through the RIS device (e.g., the RIS device 620 of FIG. 6). According to an embodiment, the base station may configure a specific RIS RP corresponding to the RIS off resource so that the specific RIS RP may measure a size that offsets ICI.

Referring to FIG. 7, mapping between one RIS-IM and one RIS-RP may be configured in units of slots. For example, CSI-RS resources 701 and 706 may be allocated in each of the first and sixth slots, and RIS-IM resources 702 to 705 may be allocated in each of the second to fifth slots. For example, RIS OFF and the first RIS-IM 702 may be mapped in the second slot, RIS RP 1 (e.g., 711) and the second RIS-IM 703 may be mapped in the third slot, and RIS RP K−1 (e.g., 714) and the fourth RIS-IM 705 may be mapped in the fifth slot.

According to an embodiment, the base station may leave the time-frequency resource to which RIS-IM is mapped empty. According to an embodiment, the base station may transmit the RIS RP value to which the RIS-IM is mapped to the RIS controller in the RIS device.

According to an embodiment, the RIS controller in the RIS device may apply and/or allocate the RIS RP value received from the base station to the mapped reference signal resource.

According to an embodiment, the UE may measure the RSSI (or RSRP) value of the signal strength (=ICI+RIS path) received in the reference signal resource to which the RIS RP is mapped. According to an embodiment, the UE may measure the RSSI value of the signal strength (=ICI) received in the reference signal resource mapped to RIS OFF.

According to an embodiment, the base station may determine whether to use the RIS device for coverage extension (or for increasing desired signal RSRP or RSSI) or for mitigating ICI.

According to an embodiment, the base station may compare the increment of the RSSI (or RSRP) measured through the CSI-RS when the RIS device is used for coverage extension with the decrement of the RSSI (or RSRP) measured through the RIS-IM when the RIS device is used for ICI mitigation and determine the purpose of using the RIS device according to the comparison result.

For example, when Γ: specific RIS RP, the increment (ΔRSRP_{d}) of the RSRP measured through the CSI-RS when it is used for coverage extension and the decrement (ΔRSSIᵢₙₜₑᵣ) measured through the RIS-IM when it is used for ICI mitigation may be determined based on Equation 1.

$$\begin{matrix}Δ {RSRP}_{d} {=}^{Δ} {max}_{Γ} RSRP ( Γ ) - RSRP ( RIS off ) \\ Δ {RSSI}_{inter} {=}^{Δ} {min}_{Γ} RSRP ( Γ ) - RSRP ( RIS off )\end{matrix} \qquad [ Equation 1 ]$$

For example, when |ΔRSRP_{d}|>|ΔRSRPᵢₙₜₑᵣ| based on Equation 1, the base station may use the RIS device for coverage extension. For example, when |ΔRSRP_{d}|<|ΔRSRPᵢₙₜₑᵣ| based on Equation 1, the base station may use the RIS device for ICI mitigation.

According to an embodiment, when the CQI reported by the UE through the CSI-RS in a state in which the RIS device is used for coverage extension, the base station may compare the increment of the RSSI (or RSRP) measured through the CSI-RS when the RIS device is used for coverage extension with the decrement of the RSSI (or RSRP) measured through the RIS-IM when the RIS device is used for ICI mitigation and determine the purpose of using the RIS device according to the comparison result.

According to an embodiment, when the CQI reported by the UE through the CSI-RS in a state in which the RIS device is used for coverage extension, the base station may configure the RIS-IM through the DCI and perform a procedure for using the RIS device for ICI mitigation.

According to an embodiment, when the purpose of the RIS device is changed (e.g., coverage extension to ICI mitigation), the base station may transmit the RP pattern corresponding to the smallest RSSI value fed back through the RIS-IM to the RIS controller in the RIS device in the next slot (or TTI).

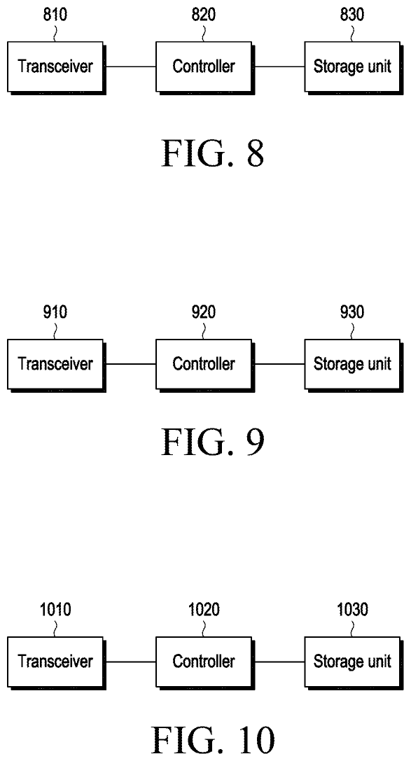

FIG. 8 illustrates a structure of a base station according to an embodiment of the disclosure.

The base station of FIG. 8 may be any one of the base stations described in FIGS. 1 to 7 and 11. Referring to FIG. 8, the base station may include a transceiver 810, a controller 820, and a storage unit 830. In the disclosure, the controller may be defined as a circuit, an application-specific integrated circuit, or at least one processor.

The transceiver 810 may transmit and receive signals to and from other entities, and may also be referred to as a transmission/reception unit.

The controller 820 may control the overall operation of the base station according to an embodiment proposed in the disclosure and may also be referred to as a processor. For example, the controller 820 may control inter-block signal flow to perform the operations according to the above-described flowchart. Specifically, the controller 820 may control the operations of the base station described above with reference to FIGS. 1 to 7 and 11.

The storage unit 830 may store at least one of information transmitted/received via the transceiver 810 and information generated via the controller 820. For example, the storage unit 830 may store information and data necessary for the method described above with reference to FIGS. 1 to 7 and 11.

According to an embodiment, the controller 820 may control to transmit RIS-IM resource configuration information including first information for allocating an RIS interference measurement (IM) resource for each RIS reflecting pattern (RP) of the RIS device and second information indicating periodicity information about the RIS-IM resource. According to an embodiment, the controller 820 may control to transmit report configuration information about the RIS-IM resource to the UE. The RIS-IM resource may be a reference resource configured for signal measurement through the RIS device by the UE.

According to an embodiment, the controller 820 may receive, from the UE, measurement information obtained by measuring a signal transmitted through the RIS device by the UE in the RIS-IM resource based on the report configuration information.

According to an embodiment, a different RIS-IM resource may be allocated to each of a plurality of RIS RPs implemented in the RIS device, and a number of the RIS-IM resources may be preset.

According to an embodiment, the controller 820 may transmit the second information including a slot periodicity through higher layer signaling, or transmit the second information including an RIS-IM resource set triggering field through downlink control information (DCI).

According to an embodiment, the report configuration information about the RIS-IM resource may be transmitted through higher layer signaling.

According to an embodiment, the report configuration information about the RIS-IM resource may be configured for the UE to report an RIS-IM index where a smallest reference signal received power (RSRP) or RSSI is measured among a plurality of RIS-IM indexes and the RSRP or the RSSI.

According to an embodiment, the controller 820 may periodically receive the measurement information measured by the UE from the UE through a physical uplink control channel (PUCCH). According to an embodiment, the controller 820 may aperiodically receive the measurement information measured by the UE from the UE through a physical uplink shared channel (PUSCH).

According to an embodiment, the controller 820 may transmit data on a physical downlink shared channel (PDSCH) using an RIS-RP mapped to the RIS-IM index where the smallest RSRP or RSSI is measured, received from the UE.

According to an embodiment, the RIS-IM resource may be allocated in a slot unit, and include an RIS off resource for a specific RIS RP to measure a size that offsets inter-cell interference (ICI).

According to an embodiment, the controller 820 may determine whether the RIS device is used for coverage extension or for mitigating inter-cell interference (ICI), and control to transmit control information corresponding to the determination to the RIS device.

According to an embodiment, the controller 820 may determine whether the RIS device is used for the coverage extension or for mitigating the ICI, compares an increment of a received signal strength indicator (RSSI) or RSRP measured through a channel status information-reference signal (CSI-RS) when the RIS device is used for the coverage extension with a decrement of the RSSI or RSRP measured through the RIS-IM resource when the RIS device is used for mitigating the ICI.

According to an embodiment, if the increment of the RSSI or RSRP when the RIS device is used for the coverage extension is larger than the decrement of the RSSI or RSRP when the RIS device is used for mitigating the ICI, the controller 820 may determine that the RIS device is used for the coverage extension.

According to an embodiment, if the increment of the RSSI or RSRP when the RIS device is used for the coverage extension is smaller than the decrement of the RSSI or RSRP when the RIS device is used for mitigating the ICI, the controller 820 may determine that the RIS device is used for mitigating the ICI.

FIG. 9 illustrates a structure of an RIS controller according to an embodiment of the disclosure.

The RIS controller of FIG. 9 may be a device for controlling the RIS device described in FIGS. 1 to 7 and FIG. 11. The RIS controller may control the reflection pattern of reflecting elements (REs) implemented in the RIS device. According to an embodiment, the RIS controller may be implemented as a hardware device physically separate from the REs. According to an embodiment, the RIS controller may be implemented as a software program and installed in the RIS device. According to an embodiment, the RIS controller may be a hardware device or a software program implemented in the base station.

Referring to FIG. 9, the RIS controller may include a transceiver 910, a controller 920, and a storage unit 930. In the disclosure, the controller may be defined as a circuit, an application-specific integrated circuit, or at least one processor.

The transceiver 910 may transmit and receive signals to and from other entities, and may also be referred to as a transmission/reception unit.

The controller 920 may control the overall operation of the RIS device according to an embodiment proposed in the disclosure and may also be referred to as a processor. For example, the controller 920 may control inter-block signal flow to perform the operations according to the above-described flowchart. Specifically, the controller 920 may control the operations of the RIS device described above with reference to FIGS. 1 to 7 and 11.

The storage unit 930 may store at least one of information transmitted/received via the transceiver 910 and information generated via the controller 920. For example, the storage unit 930 may store information and data necessary for the method described above with reference to FIGS. 1 to 7 and 11.

FIG. 10 illustrates a structure of a UE according to an embodiment of the disclosure.

The UE of FIG. 10 may be any one of the UEs described in FIGS. 1 to 7 and 11. Referring to FIG. 10, the UE may include a transceiver 1010, a controller 1020, and a storage unit 1030. In the disclosure, the controller may be defined as a circuit, an application-specific integrated circuit, or at least one processor.

The transceiver 1010 may transmit and receive signals to and from other entities, and may also be referred to as a transmission/reception unit.

The controller 1020 may control the overall operation of the UE according to an embodiment proposed in the disclosure and may also be referred to as a processor. For example, the controller 1020 may control inter-block signal flow to perform the operations according to the above-described flowchart. Specifically, the controller 1020 may control the operations of the UE described above with reference to FIGS. 1 to 7 and 11.

The storage unit 1030 may store at least one of information transmitted/received via the transceiver 1010 and information generated via the controller 1020. For example, the storage unit 1030 may store information and data necessary for the method described above with reference to FIGS. 1 to 7 and 11.

According to an embodiment, the controller 1020 may receive, from a base station, RIS-IM resource configuration information including first information for allocating an RIS interference measurement (IM) resource for each RIS reflecting pattern (RP) of the RIS device and second information indicating periodicity information about the RIS-IM resource.

According to an embodiment, the controller 1020 may receive, from the base station, report configuration information about the RIS-IM resource. The RIS-IM resource may be a reference resource configured for signal measurement through the RIS device by the UE.

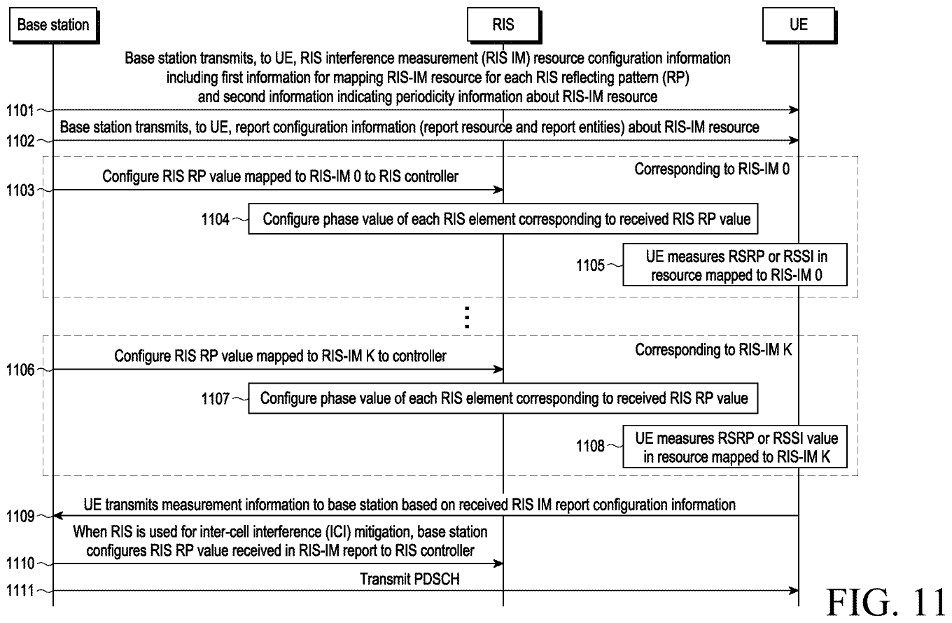

FIG. 11 is a flowchart illustrating operations of a base station, an RIS, and a UE according to an embodiment of the disclosure.

Referring to FIG. 11, in operation 1101, the base station may transmit, to the UE, RIS-IM resource configuration information including first information for mapping an RIS interference measurement (IM) resource for each RIS reflecting pattern (RP) and second information indicating periodicity information about the RIS-IM resource.

In operation 1102, the base station may transmit report configuration information (report resource and report entities) about the RIS-IM resource to the UE.

In operation 1103, the base station may configure the RIS RP value mapped to the first RIS-IM (e.g., RIS-IM 0) to the RIS controller. In operation 1104, the RIS (or RIS controller) may configure a phase value of each RIS element corresponding to the received RIS RP value. In operation 1105, the UE may measure the RSRP or RSSI value in the resource mapped to the first RIS-IM (e.g., RIS-IM 0).

In operation 1106, the base station may set the RIS RP value mapped to the second RIS-IM (e.g., RIS-IM K) to the RIS controller. In operation 1107, the RIS (or RIS controller) may configure a phase value of each RIS element corresponding to the received RIS RP value. In operation 1108, the UE may measure the RSRP or RSSI value in the resource mapped to the second RIS-IM (e.g., RIS-IM K).

In operation 1109, the UE may transmit measured measurement information (e.g., the RSRP or RSSI value) measured based on the received RIS-IM configuration information to the base station. In operation 110, the base station may configure the RIS RP value received in the RIS-IM report to the RIS controller when the RIS is used for mitigating inter-cell interference (IC). In operation 1111, the base station may transmit data and/or information to the UE through a physical downlink shared channel (PDSCH).

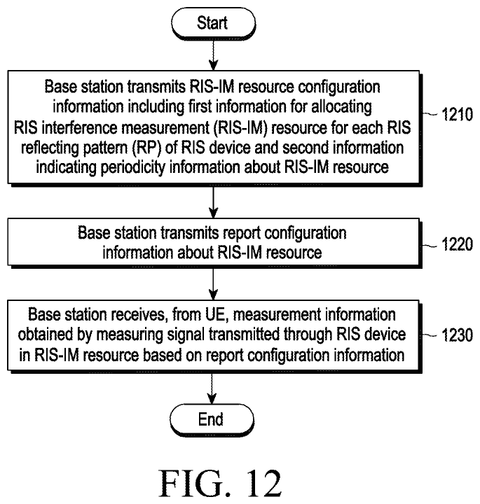

FIG. 12 is a flowchart illustrating operations of a base station according to an embodiment of the disclosure.

Referring to FIG. 12, in operation 1210, a base station controlling an RIS device in a wireless communication system may transmit RIS-IM resource configuration information including first information for allocating an RIS interference measurement (IM) resource for each RIS reflecting pattern (RP) of the RIS device and second information indicating periodicity information about the RIS-IM resource. The RIS-IM resource may be a reference resource configured for signal measurement through the RIS device by the UE.

In operation 1220, the base station may transmit report configuration information about the RIS-IM resource to the UE.

In operation 1230, the base station may receive, from the UE, measurement information obtained by measuring a signal transmitted through the RIS device by the UE in the RIS-IM resource based on the report configuration information.

The methods according to the embodiments descried in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Meanwhile, although specific embodiments of the present disclosure have been described above, various changes may be made thereto without departing from the scope of the present disclosure. Thus, the scope of the present invention should not be limited to the above-described embodiments, and should rather be defined by the following claims and equivalents thereof.

1. A base station controlling a reconfigurable intelligent surface (RIS) device in a wireless communication system, comprising:
a transceiver; and
a controller configured to control to:
transmit RIS-IM resource configuration information including first information for allocating an RIS interference measurement (IM) resource for each RIS reflecting pattern (RP) of the RIS device and second information indicating periodicity information about the RIS-IM resource; and
transmit, to a user equipment (UE), report configuration information about the RIS-IM resource,
wherein the RIS-IM resource is a reference resource configured for signal measurement through the RIS device by the UE.

2. The base station of claim 1, wherein the controller is configured to receive, from the UE, measurement information obtained by measuring a signal transmitted through the RIS device by the UE in the RIS-IM resource based on the report configuration information.

3. The base station of claim 1, wherein a different RIS-IM resource is allocated to each of a plurality of RIS RPs implemented in the RIS device, and wherein a number of the RIS-IM resources is preset.

4. The base station of claim 1, wherein the controller is configured to:
transmit the second information including a slot periodicity through higher layer signaling; or
transmit the second information including an RIS-IM resource set triggering field through downlink control information (DCI).

5. The base station of claim 1, wherein the report configuration information about the RIS-IM resource is transmitted through higher layer signaling.

6. The base station of claim 1, wherein the report configuration information about the RIS-IM resource is configured for the UE to report an RIS-IM index where a smallest reference signal received power (RSRP) or received signal strength indicator (RSSI) is measured among a plurality of RIS-IM indexes and the RSRP or the RSSI.

7. The base station of claim 2, wherein the controller is configured to:
periodically receive, from the UE, the measurement information measured by the UE through a physical uplink control channel (PUCCH); or
aperiodically receive, from the UE, the measurement information measured by the UE through a physical uplink shared channel (PUSCH).

8. The base station of claim 6, wherein the controller is configured to transmit data on a physical downlink shared channel (PDSCH) using an RIS-RP mapped to the RIS-IM index where the smallest RSRP or RSSI is measured, received from the UE.

9. The base station of claim 1, wherein the RIS-IM resource is allocated in a slot unit, and includes an RIS off resource for a specific RIS RP to measure a size that offsets inter-cell interference (ICI).

10. The base station of claim 1, wherein the controller is configured to:
determine whether the RIS device is used for coverage extension or for mitigating inter-cell interference (ICI); and
transmit control information corresponding to the determination to the RIS device.

11. The base station of claim 10, wherein to determine whether the RIS device is used for the coverage extension or for mitigating the ICI, the controller is configured to compare an increment of a received signal strength indicator (RSSI) or RSRP measured through a channel status information-reference signal (CSI-RS) when the RIS device is used for the coverage extension with a decrement of the RSSI or RSRP measured through the RIS-IM resource when the RIS device is used for mitigating the ICI.

12. The base station of claim 11, wherein the controller is configured to:
determine that the RIS device is used for the coverage extension if the increment of the RSSI or RSRP when the RIS device is used for the coverage extension is larger than the decrement of the RSSI or RSRP when the RIS device is used for mitigating the ICI; and
determine that the RIS device is used for mitigating the ICI if the increment of the RSSI or RSRP when the RIS device is used for the coverage extension is smaller than the decrement of the RSSI or RSRP when the RIS device is used for mitigating the ICI.

13. A UE measuring a signal using a reconfigurable intelligent surface (RIS) in a wireless communication system, comprising:
a transceiver, and
a controller configured to control to:
receive, from a base station, RIS-IM resource configuration information including first information for allocating an RIS interference measurement (IM) resource for each RIS reflecting pattern (RP) of the RIS device and second information indicating periodicity information about the RIS-IM resource; and
receive, from the base station, report configuration information about the RIS-IM resource,
wherein the RIS-IM resource is a reference resource configured for signal measurement through the RIS device by the UE.

14. A method for operating a base station controlling a reconfigurable intelligent surface (RIS) device in a wireless communication system, the method comprising:
transmitting RIS-IM resource configuration information including first information for allocating an RIS interference measurement (IM) resource for each RIS reflecting pattern (RP) of the RIS device and second information indicating periodicity information about the RIS-IM resource; and
transmitting, to a UE, report configuration information about the RIS-IM resource,
wherein the RIS-IM resource is a reference resource configured for signal measurement through the RIS device by the UE.

15. A method for operating a UE measuring a signal using a reconfigurable intelligent surface (RIS) in a wireless communication system, the method comprising:
receiving, from a base station, RIS-IM resource configuration information including first information for allocating an RIS interference measurement (IM) resource for each RIS reflecting pattern (RP) of the RIS device and second information indicating periodicity information about the RIS-IM resource; and
receiving, from the base station, report configuration information about the RIS-IM resource,
wherein the RIS-IM resource is a reference resource configured for signal measurement through the RIS device by the UE.
